(19) United States
(12) Patent Application Publication
(10) Pub. No.: US 2026/0221870 A1
(43) Pub. Date: Jul. 30, 2026

(54) POWER DISTRIBUTION PROMPT DOSE SOFT START UPSET MITIGATION CIRCUIT

(71) Applicant: Raytheon Company, Arlington, VA (US)

(72) Inventors: Kay Carol Chesnut, Redondo Beach, CA (US); Bruce Jex Lindsay, San Clemente, CA (US); Philip C. Todd, San Pedro, CA (US); Dale D. Kachuche, Los Angeles, CA (US); Fanny Hiebel, Redondo Beach, CA (US); Manuel Herrera, Hawthorne, CA (US); Alfredo Rene Lara, Norwalk, CA (US); Andy Soto, Long Beach, CA (US)

(21) Appl. No.: 19/041,504

(22) Filed: Jan. 30, 2025

(51) Int. Cl. H02M 1/36; H02M 3/158

(52) U.S. Cl. CPC H02M 1/36; H02M 3/158

(57) ABSTRACT

A pulse width modulator (PWM) system includes a pulse width modulator (PWM) integrated circuit (IC) and a prompt dose mitigation circuit. The PWM IC is configured to output power to a load. The PWM IC includes a soft start (SS) circuit configured to perform a SS operation that sets a SS ramp time duration which controls a startup sequence operation of the PWM IC. The prompt dose mitigation circuit is electrically connected to a SS input of the SS circuit. The prompt dose mitigation circuit is configured to control the SS circuit to reduce the SS upset time duration of the startup sequence operation.

### GOVERNMENT LICENSE RIGHTS

This disclosure was made with Government support under Contract No. HQ0856-21-C-0003. The Government has certain rights in the disclosure.

### BACKGROUND

The present disclosure relates to pulse width modulator systems and to a power distribution prompt dose soft start upset mitigation circuit.

Pulse Width Modulator (PWM) integrated circuits are widely used in power distribution systems due to their ability to regulate and control power efficiently across various loads. Power distribution systems often demand precise control over voltage and current levels to supply power to sensitive components and to manage dynamic load changes. A PWM IC can control power distribution by adjusting the duty cycle of the output signal, enabling efficient power conversion and delivery to multiple devices or sub-systems. This PWM IC can also incorporate key protective features such as soft start (SS), overcurrent protection, and under voltage lockout (UVLO), making it highly suitable for applications where stability, reliability, and safety are crucial.

### SUMMARY

According to a non-limiting embodiment, a pulse width modulator (PWM) system includes a pulse width modulator (PWM) integrated circuit (IC) and a prompt dose mitigation circuit. The PWM IC is configured to output power to a load. The PWM IC includes a soft start (SS) circuit configured to perform a SS operation that sets a SS ramp time duration which controls a startup sequence operation of the PWM IC. The prompt dose mitigation circuit is electrically connected to a SS input of the SS circuit. The prompt dose mitigation circuit is configured to control the SS circuit to reduce the SS upset time duration of the startup sequence operation.

In addition to one or more of the features described above, or as an alternative to any of the foregoing embodiments, a reset of the startup sequence operation is initiated when a voltage level of voltage applied to the SS input is below a reset voltage threshold for a predetermined time duration.

In addition to one or more of the features described above, or as an alternative to any of the foregoing embodiments, the prompt dose mitigation circuit comprises an SS ramp tuning circuit configured to control a rate at which the voltage applied to the SS input ramps up and discharges; and a reset circuit in signal communication with the SS ramp tuning circuit, the reset circuit configured to apply the voltage to the SS input having the voltage level that is below the reset voltage threshold for the predetermined time duration that initiates a reset of the startup sequence operation.

In addition to one or more of the features described above, or as an alternative to any of the foregoing embodiments, the SS ramp tuning circuit comprises a first SS capacitor including a first terminal connected to a ground reference and an opposing second terminal; a second SS capacitor including a first terminal connected to the ground reference and an opposing second terminal connected to the second terminal of the first SS capacitor; and a SS resistor including a first terminal connected to the SS input and an opposing second terminal connected to the second terminals of the first and second SS capacitors.

In addition to one or more of the features described above, or as an alternative to any of the foregoing embodiments, the reset circuit comprises a pull down switch including a switch input to receive a trigger current and a switch output connected to the SS input to apply the voltage in response to receiving the trigger current; a timing resistor including a first resistor terminal connected to the switch input and an opposing second resistor terminal; a trigger capacitor including a first capacitor terminal connected to the second resistor terminal of the timing resistor and an opposing second capacitor terminal connected to the ground reference; a leakage resistor including a first resistor terminal connected to the first capacitor terminal of the trigger capacitor and an opposing second resistor terminal connected to the ground reference; a p-type semiconductor- intrinsic semiconductor region-n-type semiconductor (PIN)diode including a cathode connected to the first resistor terminal of the leakage resistor, the first capacitor terminal of the trigger capacitor and the second resistor terminal of the timing resistor, and including an anode configured to establish electrical connection with a bias voltage source to receive a bias voltage; and a bias capacitor including a first capacitor terminal connected to the ground reference and an opposing second capacitor terminal configured to establish electrical connection with the bias voltage source to receive the bias voltage.

In addition to one or more of the features described above, or as an alternative to any of the foregoing embodiments, the PIN diode generates the trigger current in response to detecting a prompt dose.

In addition to one or more of the features described above, or as an alternative to any of the foregoing embodiments, the PIN diode is a PIN photodiode.

In addition to one or more of the features described above, or as an alternative to any of the foregoing embodiments, the pull down switch is a transistor including: an emitter connected to the ground reference; a collector connected to the SS input to establish the switch output; and a base connected to first resistor terminal of the timing resistor to establish the switch input and receive the trigger current that is output from the PIN diode.

According to another non-limiting embodiment, a prompt dose mitigation circuit comprises a soft start (SS) ramp tuning circuit and a reset circuit in signal communication with the SS ramp tuning circuit. The SS ramp tuning circuit is configured to control a rate at which voltage applied to a SS input of a SS circuit included in a pulse width modulator (PWM) integrated circuit (IC) ramps up and discharges. The reset circuit is configured to apply the voltage to the SS input having a voltage level that is below a reset voltage threshold for the predetermined time duration that initiates a reset of a startup sequence operation performed by the SS circuit.

In addition to one or more of the features described above, or as an alternative to any of the foregoing embodiments, the prompt dose mitigation circuit comprises an SS ramp tuning circuit configured to control a rate at which the voltage applied to the SS input ramps up and discharges; and a reset circuit in signal communication with the SS ramp tuning circuit, the reset circuit configured to apply the voltage to the SS input having the voltage level that is below the reset voltage threshold for the predetermined time duration that initiates a reset of the startup sequence operation.

In addition to one or more of the features described above, or as an alternative to any of the foregoing embodiments, the SS ramp tuning circuit comprises a first SS capacitor including a first terminal connected to a ground reference and an opposing second terminal; a second SS capacitor including a first terminal connected to the ground reference and an opposing second terminal connected to the second terminal of the first SS capacitor; and a SS resistor including a first terminal connected to the SS input and an opposing second terminal connected to the second terminals of the first and second SS capacitors.

In addition to one or more of the features described above, or as an alternative to any of the foregoing embodiments, the reset circuit comprises a pull down switch including a switch input to receive a trigger current and a switch output connected to the SS input to apply the voltage in response to receiving the trigger current; a timing resistor including a first resistor terminal connected to the switch input and an opposing second resistor terminal; a trigger capacitor including a first capacitor terminal connected to the second resistor terminal of the timing resistor and an opposing second capacitor terminal connected to the ground reference; a leakage resistor including a first resistor terminal connected to the first capacitor terminal of the trigger capacitor and an opposing second resistor terminal connected to the ground reference; a PIN diode including a cathode connected to the first resistor terminal of the leakage resistor, the first capacitor terminal of the trigger capacitor and the second resistor terminal of the timing resistor, and including an anode configured to establish electrical connection with a bias voltage source to receive a bias voltage; and a bias capacitor including a first capacitor terminal connected to the ground reference and an opposing second capacitor terminal configured to establish electrical connection with the bias voltage source to receive the bias voltage.

In addition to one or more of the features described above, or as an alternative to any of the foregoing embodiments, the PIN diode generates the trigger current in response to detecting a prompt dose.

In addition to one or more of the features described above, or as an alternative to any of the foregoing embodiments, the PIN diode is a PIN photodiode.

In addition to one or more of the features described above, or as an alternative to any of the foregoing embodiments, the pull down switch is a transistor including: an emitter connected to the ground reference; a collector connected to the SS input to establish the switch output; and a base connected to first resistor terminal of the timing resistor to establish the switch input and receive the trigger current that is output from the PIN diode.

According to yet another non-limiting embodiment, a method is provided for controlling a soft start (SS) circuit to control a startup sequence operation performed by a SS circuit included in a pulse width modulator (PWM) integrated circuit (IC). The method comprises electrically connecting a prompt dose mitigation circuit to a SS input of the SS circuit, and detecting a prompt does event via the prompt does mitigation circuit. The method further comprises initiating a reset of the startup sequence operation in response to detecting the prompt dose event, and outputting a voltage from the prompt dose mitigation circuit to the SS input to reduce the SS upset time duration of the startup sequence operation.

In addition to one or more of the features described above, or as an alternative to any of the foregoing embodiments, the reset of the startup sequence operation is initiated when a voltage level of the voltage applied to the SS input is below a reset voltage threshold for a predetermined time duration.

In addition to one or more of the features described above, or as an alternative to any of the foregoing embodiments, the method further comprises applying the voltage to the SS input using a reset circuit included in the prompt dose mitigation circuit, the voltage having the voltage level that is below the reset voltage threshold for the predetermined time duration that initiates a reset of the startup sequence operation; and connecting a SS ramp tuning circuit included in the prompt dose mitigation circuit to the SS input to control a rate at which the voltage applied to the SS input ramps up and discharges.

In addition to one or more of the features described above, or as an alternative to any of the foregoing embodiments, the method further comprises delivering a trigger current to a pull down switch included in the reset circuit; and applying the voltage to the SS input via the pull down switch receiving the trigger current.

In addition to one or more of the features described above, or as an alternative to any of the foregoing embodiments, the method further comprises detecting the prompt dose event via a PIN diode included in the reset circuit; and outputting the trigger current from the PIN diode in response to detecting the prompt dose event.

In addition to one or more of the features described above, or as an alternative to any of the foregoing embodiments, the method further comprises detecting radiation energy produced in response to the prompt dose event via the PIN diode, and outputting the trigger current from the PIN diode in response to detecting the radiation energy.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIGS. 1A and 1B depict a circuit diagram of a pulse width modulator (PWM) circuit according to a non-limiting embodiment of the present disclosure;

FIG. 2 is a block diagram illustrating a pulse width modulator (PWM) system according to a non-limiting embodiment of the present disclosure;

FIG. 3 is a block diagram illustrating a prompt dose mitigation circuit included in a PWM system according to a non-limiting embodiment of the present disclosure;

FIG. 4 depicts the prompt dose mitigation circuit shown in FIG. 3 following a prompt dose event; and

FIG. 5 is a flow diagram illustrating a method of mitigating power distribution following a prompt dose soft start upset according to a non-limiting embodiment of the present disclosure.

### DETAILED DESCRIPTION

PWM ICs often implement various protective features that are useful when implemented in power distribution systems. One such feature includes a soft start (SS) operation, which is designed to manage the initial startup sequence of the PWM IC. The SS operation prevents sudden inrush currents and voltage overshoots when the power supply is first turned on by causing a gradual ramp up of the output voltage or duty cycle over a specified period, allowing the system to stabilize smoothly and safely. By gradually ramping up the output during startup through the SS feature, the PWM IC can minimize inrush currents and prevent damage to components.

The SS operation, however, can be vulnerable to prompt dose events in high-radiation environments, such as those involving gamma radiation from nuclear events. Exposure to these events can disrupt the PWM IC’s function for several milliseconds. This interrupts the output to connected loads, causing them to experience brownout or be completely taken offline. Current circuits often use an external capacitor in the SS reset circuit to adjust the duration of the SS ramp time. The SS capacitor must be discharged by an internal discharge circuit until the SS pin potential reaches the internal SS circuit’s reset threshold. This will cause milliseconds long PWM output outage times. Simple solutions using an external resistor to protect the SS cap from discharging did mitigate and reduce the upset duration, but did not prevent brownout. During this outage, the PWM’s output voltage will droop depending on the load and the output energy storage, and downstream circuitry will upset due to brownout or even total loss of voltage. The solution presented herein purposefully pulls the SS pin below the SS circuit reset threshold with a long enough pulse duration to guarantee reset, balanced by a short enough duration that the PWM outputs re-start quickly enough to prevent brownout with minimal energy storage, and prevent downstream circuit upset.

Various non-limiting embodiments of the present disclosure provide a prompt dose mitigation circuit capable of reducing the soft start upset duration by 2 orders of magnitude compared to conventional solutions. The prompt dose mitigation circuit also includes and provides a leakage path that prevents low level persistent background radiation and quiescent leakage from inadvertently resetting the PWM IC. In this manner, the prompt dose mitigation circuit permits the output load to operate through prompt dose events without impacting downstream hardware.

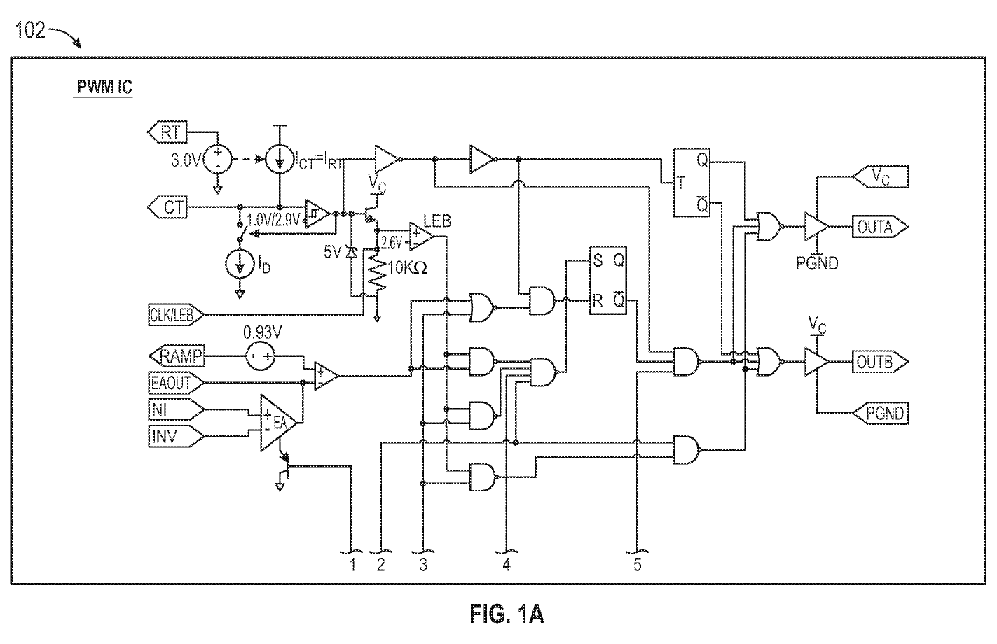

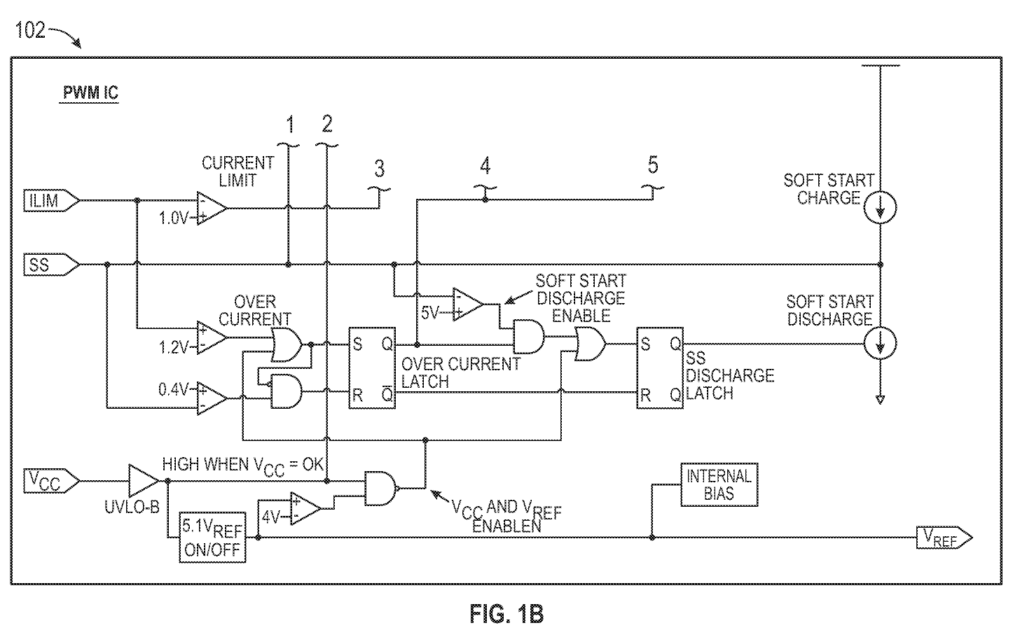

With reference now to FIGS. 1A and 1B, a circuit diagram of a pulse width modulator (PWM) integrated circuit (IC) 102 is illustrated according to a non-limiting embodiment of the present disclosure. The PWM IC 102 utilizes a comparator-driven mechanism to generate PWM signals based on input parameters like the ramp signal, error amplifier output, and feedback signals. The soft-start (SS) circuit ensures a gradual startup by charging a corresponding capacitor to ramp up the duty cycle, which helps prevent inrush current and stress on power components. If faults such as overcurrent or under-voltage conditions occur, for example, the SS discharge circuit rapidly discharges the corresponding capacitor to halt operation safely, protecting the system and its connected load.

The PWM IC 102 also includes a current limiter (ILIM) circuit for current monitoring and protection. When the sensed current exceeds a defined threshold, the ILIM circuit triggers an overcurrent protection mechanism, disabling the output and engaging the soft-start discharge. Additionally, the PWM IC 102 includes an under-voltage lockout (UVLO) circuit that monitors the supply voltage to ensure stable operation, enabling the PWM output only when the input voltage and a reference voltage (Vref) are within a safe range as described in greater detail below.

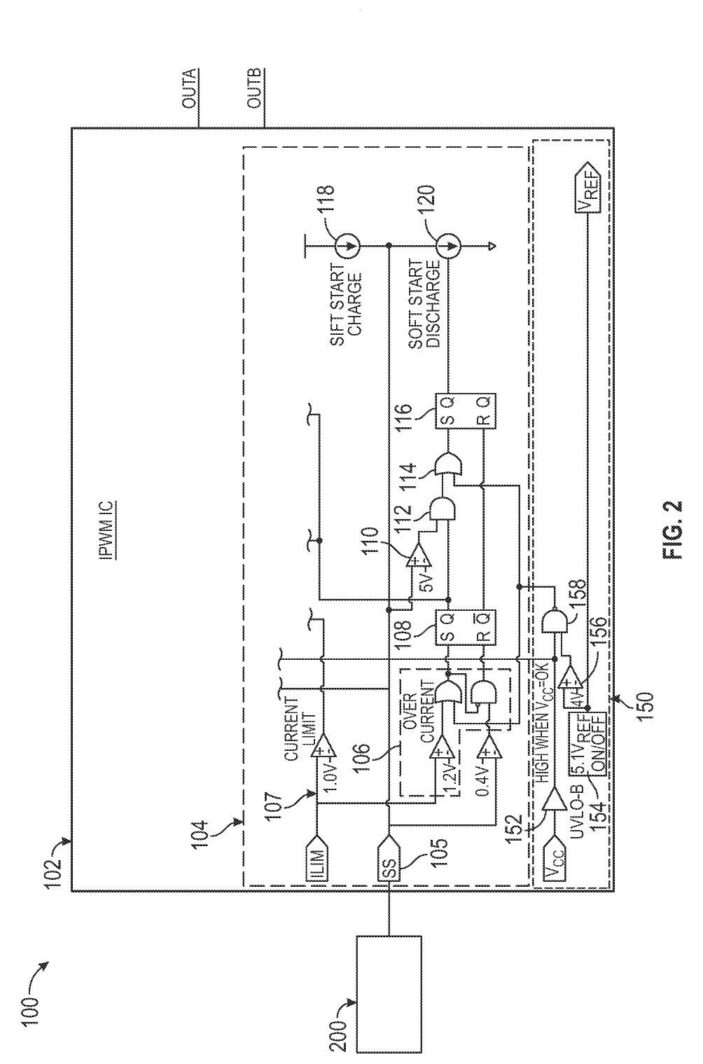

Turning to FIG. 2, a PWM system 100 is illustrated according to a non-limiting embodiment of the present disclosure. The PWM system 100 includes the PWM integrated circuit (IC) 102 and a prompt dose mitigation circuit 200. The PWM IC 102 is configured to efficiently control the dual outputs (OutputA, OutputB) by adjusting the duty cycle of an output signal, providing features like soft start, overcurrent protection, and under voltage lockout (UVLO) to ensure stable and safe operation in power management applications. In a non-limiting embodiment, the PWM IC 102 is implemented as a IS9-1825x PWM manufactured by Renesas Electronics Corp. The prompt dose mitigation circuit 200 reduces the soft start upset duration by two orders of magnitude such that volume efficient energy storage permits the output load to ride through the smaller PWM upset without impacting downstream hardware. Although the prompt dose mitigation circuit 200 is illustrated as being external from the PWM IC 102, it should be appreciated that the PWM IC 102 and the prompt dose mitigation circuit 200 can be integrated as a single integrated chip.

The PWM IC 102 includes an internal PWM soft start (SS) circuit 104 (referred herein as a SS circuit 104) and an UVLO circuit 150. It should be appreciated that the PWM IC 102 can include additional circuits without departing from the scope of the invention. The SS circuit 104 is configured to manage a startup sequence of the PWM IC 102 and prevent sudden inrush currents and voltage overshoots when power supply is initiated, e.g., from 0V to target device power supply (Vcc).

The SS circuit 104 includes an overcurrent circuit 106, an over current latch 108, a SS discharge enable comparator 110, a SS discharge AND gate 112 (e.g., a digital logic “AND gate”), a SS discharge OR gate 114 (e.g., a digital logic “OR gate”), a SS discharge latch 116, a SS charge current source 118, and a SS discharge current source 120. The over current circuit 106 is configured to monitor the current level and triggers when an overcurrent condition exists and the current exceeds a target threshold. The over current latch 108 is configured to hold (i.e., “latch”) the signal until the circuit is reset when the SS pin 105 goes below the SS reset comparator threshold. Accordingly, the over current latch 108 can ensure that the soft start discharge is engaged in case of an overcurrent event. In a non-limiting embodiment, one or more SS capacitors (not shown) can be connected to the SS circuit input 105, which controls or “tunes” the startup ramp time of the SS circuit 104. The value and/or number of SS capacitors are selected based on the target ramp rate of the PWM system 100.

The SS discharge enable comparator 110 is configured to enable the overcurrent latch 108 which triggers SS capacitor discharge. The SS discharge AND gate 112 combines the SS discharge enable comparator output 110 with the output of the overcurrent latch 108 to provide an output that is used with the SS discharge OR gate 114. This generates an output that sets the SS discharge latch 116 which starts the soft start discharge circuitry.

The discharge OR gate 114 operates as a logical control that initiates the SS discharge latch 116 when either an overcurrent condition or an under voltage lockout (UVLO) condition occurs. When the overcurrent circuit 106 detects excessive current, it sets the overcurrent latch 108 which sets the output from the discharge OR gate 114. Similarly, when the UVLO circuit 150 detects that the input voltage has dropped below a target threshold, the UVLO circuit 150 causes an output from the discharge OR gate 114 to set the SS discharge latch 116.

The SS discharge latch 116 controls the soft start process using the SS discharge current source 120 in a discharged state during fault conditions, such as overcurrent or under voltage. The SS discharge latch 116 receives an input from the SS discharge OR gate 114, which is triggered by either the overcurrent latch 108 or UVLO circuit 150. When a fault is detected, the SS discharge latch 116 maintains the discharge state of the SS discharge current source 120 until the SS pin voltage goes below the 0.4V reset threshold. If the overcurrent limit condition has cleared, the overcurrent latch 108 resets and this resets the soft start discharge latch 116 which shuts off the SS discharge current source 120. The SS charge current source 118 is no longer overwhelmed by the larger discharge current source 120 and this permits the recharging of the SS capacitor (e.g., to charge a SS capacitor connected to SS input pin 105) so that the PWM IC 102 can safely reinitiate the output ramp up.

According to a non-limiting embodiment, the SS circuit 104 interacts with the ILIM circuit 107 circuit to ensure safe operation during overcurrent conditions. When the ILIM circuit 107 detects a current level that exceeds a predefined limit (e.g., 1.0V threshold), it activates the overcurrent circuit 106 to initiate the SS reset operation and mitigate damage to the output power circuitry. Once the overcurrent condition is resolved, the overcurrent circuit 106 is deactivated to allow the PWM IC 102 to safely restart according to a controlled output ramp-up.

The UVLO circuit 150 operates when the input voltage and reference voltage (Vref) are above a safe threshold, protecting the system from low-voltage conditions. The UVLO circuit 150 includes an input buffer 152, a voltage reference source 154, a UVLO comparator 156, and a NAND gate 158 (e.g., a digital logic “NOT-AND gate”). The input buffer 152 outputs a logic high signal (e.g., a binary “1”) used by the logic of the UVLO circuit 150 when the input voltage (Vcc) reaches a target operating voltage threshold. The voltage reference source 154 is initiated to generate a voltage output (e.g., 5.1V) in response to the logic high signal. When the input voltage (Vcc) falls below the target operating voltage threshold, the input buffer 152 outputs a logic low signal (e.g., a binary “0”) that stops output of the voltage reference source 154.

The UVLO comparator 156 outputs a logic high signal (e.g., binary “1”) when the difference between the positive terminal and negative terminal is positive and outputs a logic low signal (e.g., binary “0”) when the difference between the positive terminal and negative terminal is negative. If Vref falls below 4V the SS discharge process will be initiated by comparator 156. The NAND gate 158 receives the output from the input buffer 152 and the output from the UVLO comparator 156. Signals from the UVLO comparator 156 and/or other components of the UVLO circuit 150determine whether the PWM IC 102 should remain active or be disabled due to insufficient voltage. When, for example, the input voltage (Vcc) falls below the voltage threshold, the NAND gate 158 receives logic low inputs and in turn outputs a logic high signal. The logic high output signal is delivered to the discharge OR gate 114, which then latches the SS discharge latch 116 to trigger the soft start discharge process performed by the SS circuit 104.

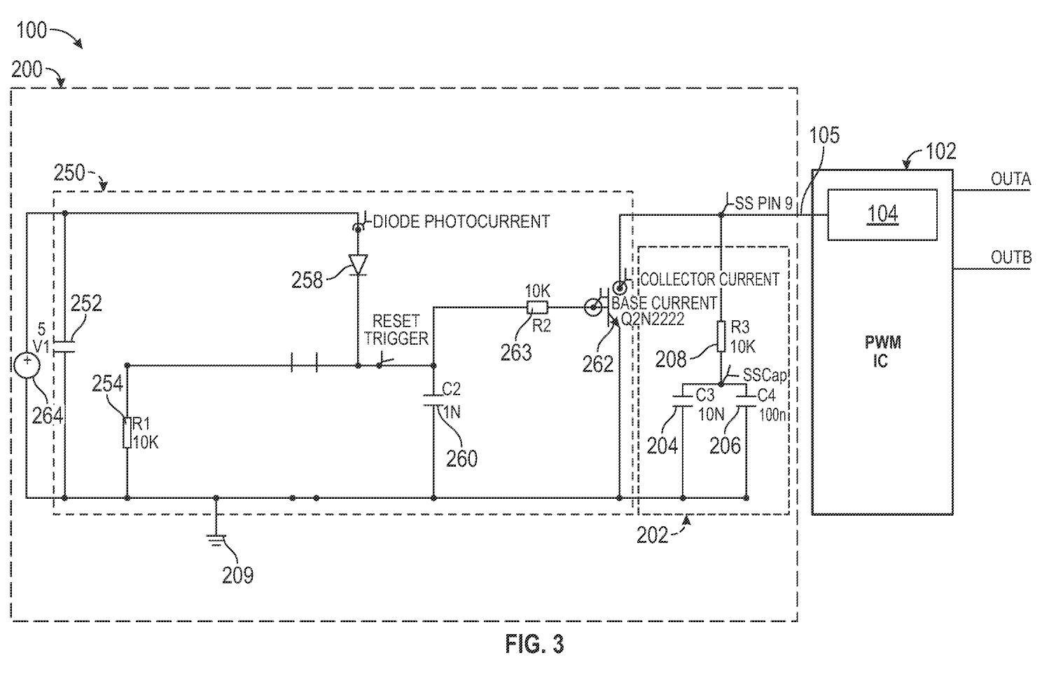

Turning now to FIG. 3, the prompt dose mitigation circuit 200 is illustrated according to a non-limiting embodiment of the present disclosure. The prompt dose mitigation circuit 200 includes a SS ramp tuning circuit 202 and a reset circuit 250. The SS ramp tuning circuit 202 sets the power up ramp time, and the reset circuit 250 deliberately pulls down the SS pin 105 below a reset voltage threshold (e.g., 0.4V) long enough to reset the SS circuit 104.

The SS ramp tuning circuit 202 controls the rate at which the soft start voltage ramps up and discharges, thereby controlling the maximum startup pulse width of the PWM outputs (OutputA, OutputB). The SS ramp tuning circuit 202 includes a first SS capacitor 204, a second SS capacitor 206, and a SS resistor 208. Although two capacitors 204 and 206 are described, the number and value of capacitors can vary based on target ramp time requirements of the application.

The first SS capacitor 204 and second SS capacitor 206 are connected in parallel with one another, each having a first terminal connected to a ground potential 209 and an opposing second terminal connected together. The SS resistor 208 includes a first terminal connected to the SS pin 105 and an opposing second terminal connected to the second terminals of the first and second SS capacitors 204, 206. Together, the first SS capacitor 204, second SS capacitor 206, and SS resistor 208 establish a time constant that controls the soft start ramp duration of the SS circuit 104. The SS resistor 208 also reduces the discharge of the first and second capacitors 204, 206 during the prompt dose reset to ensure a faster circuit recovery once the reset pulse has passed. The value of the resistor 208 is chosen so that it does not greatly impact the ramp rate during initial power up, but sufficiently protects discharging the SS capacitor 204 and/or second SS capacitor 206 during the reset pulse.

During operation, the parallel connection of the first and second SS capacitors 204, 206 establish the total capacitance at the SS pin 105. The combined capacitance (e.g., 110nF (10nF + 100nF)) provides a slower, more gradual soft start ramp-up. This ensures a controlled and smooth increase in the duty cycle of the PWM outputs(OutputA, OutputB_ which reduces inrush currents and stress on the power components during startup. The SS resistor 208 limits the current flowing out of the SS pin 105. Accordingly, the resistance provided by the SS resistor 208 impacts the charging rate of the capacitance established by the first and second capacitors 204, 206 and sets the charging rate of the voltage appearing at the SS pin 105. The SS ramp tuning circuit 202can be designed where the value of the SS resistor 208 has minimal impact on the capacitance charge rate.

The reset circuit 250 includes a bias capacitor 252, a leakage resistor 254 to bleed off leakage current, a p-type semiconductor- intrinsic semiconductor region-n-type semiconductor (PIN) diode 258, a trigger capacitor 260, a timing resistor 263, and a pull down switch 262. The reset circuit 250 is configured to receive a bias voltage from a bias voltage source 264. According to a non-limiting embodiment, the bias voltage is set at 5V. It should be appreciated, however, that the bias voltage can be selected based on the rating of the PIN diode 258.

According to a non-limiting embodiment, the PIN diode 258 is a PIN photodiode, which detects a prompt dose event and in response generates photocurrents that initiate the reset circuit 250. In a non-limiting embodiment, the PIN diode 258 is capable of detecting radiation energy such as gamma radiation, for example, produced during a prompt dose event. Accordingly, the trigger capacitor 260 is configured to “sense” prompt dose initiation of the PIN diode 258 by realizing a voltage change across the capacitor 260 when the PIN diode 258 conducts sufficient current to overcome the effects of the leakage resistor 254. The leakage resistor 254 includes a first terminal connected to the output of the PIN diode 258 and an opposing second terminal connected to the ground potential 209.

In some applications, the PWM system 100 is implemented in an environment that exposes the reset circuit 250 to persistent radiation. In these scenarios, lower-level background radiation will cause the PIN diode 258 to generate low levels of photocurrent, which behaves like a leakage current. Notwithstanding the persistent background radiation, the reset circuit 250 must maintain the pull down switch 262 off to prevent inadvertent reset of the SS circuit 104 during normal operation. Accordingly, the leakage resistor 254 maintains the pull down switch 262 off during normal operation by draining the leakage from the PIN diode 258 when quiescent current and persistent background radiation (e.g., radiation lower than the threshold associated with a prompt dose event) is present. The value of the leakage resistor 254 can be selected based on expected persistent background radiation doses to which the PWM system 100 will be exposed and any other sources of diode leakage such as temperature.

When activated due to a prompt dose event, the PIN diode 258 is configured to inject a sufficient amount of current (e.g., a trigger current) into the reset circuit 250 to overcome the effects of leakage resistor 254. According to a non-limiting embodiment, the PIN diode 258 is implemented as a photodetector 258 to inject a photocurrent in response to a prompt dose event.

The trigger capacitor 260 includes a first terminal connected to the ground potential 209 and an opposing second terminal in signal communication with the pull down switch 262 (e.g., via a timing resistor 263). The trigger capacitor 260 is configured to switch on the pull down switch 262 in response to the (trigger) current injected by the activated PIN diode 258. In a non-limiting embodiment, the trigger capacitor value of the trigger capacitor 260 and base resistor value of the timing resistor 263 are selected to shape the SS pin reset pulse duration. According to a non-limiting embodiment, the value of the trigger capacitor 260 is selected so that the pulse duration is greater than a non-limiting embodiment time of 3.5 microseconds (µS) to pull down the SS pin 105 and successfully reset the SS pin 105 below the reset threshold which reduces the PWM outage duration to a target outage duration. In at least one non-limiting embodiment, the reset duration is inadequate if the target outage duration is less than 3.0 µS.

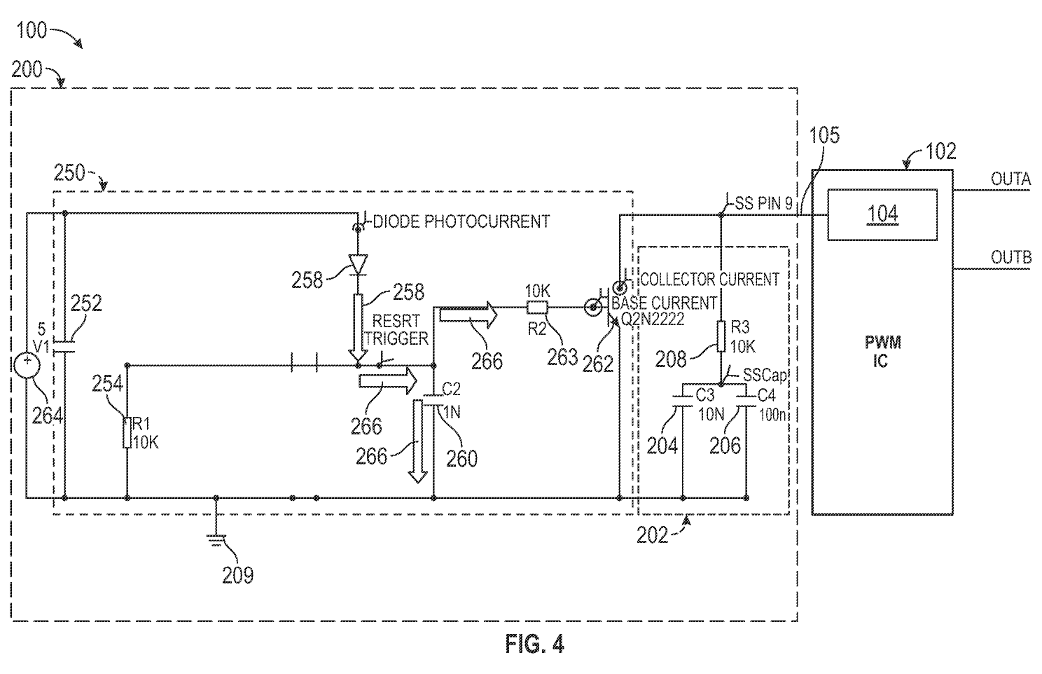

FIG. 4 illustrates the operation of the prompt dose mitigation circuit 200 following a prompt dose event. The prompt dose event causes the PIN diode 258 to inject a current 266 (e.g., photocurrent 266). The injected current 266 charges the trigger capacitor 260 until the pull down switch 262 is switched on. According to a non-limiting embodiment, the pull down switch 262 is implemented as a bipolar junction transistor (BJT) 262 that utilizes a timing resistor 263 to control the current delivered to the BJT base terminal. In response to switching on the pull down switch 262, the SS pin 105 is forced to drop below 0.4V. Once the voltage drops below to a non-limiting embodiment voltage of 0.4Vdc, the over current circuitry 106 resets the overcurrent latch 108. The PWM 102 then returns to normal operation.

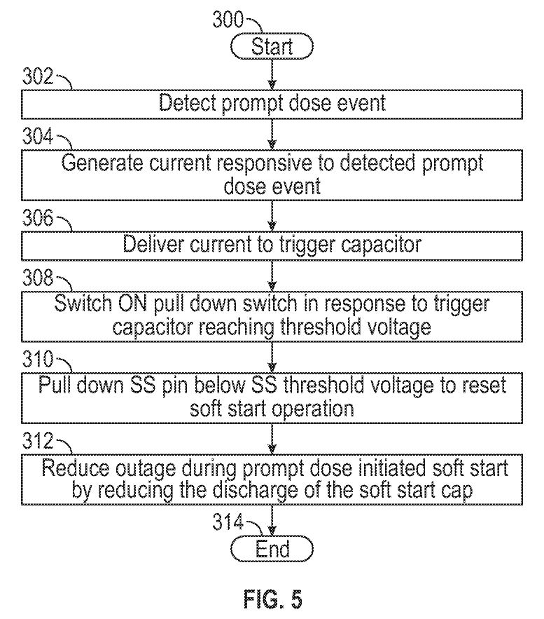

Turning now to FIG. 5, a method of mitigating power distribution of a PWM IC following a prompt dose soft start upset is illustrated according to a non-limiting embodiment of the present disclosure. The method begins at operation 300, and a prompt dose event is detected at operation 302. The prompt dose event can be detected using a PIN diode (e.g., a PIN photodiode), which generates a current at operation 304 in response to detecting the prompt dose event. At operation 306, the current is delivered to a trigger capacitor, which causes a voltage to build up across it. When the voltage reaches a threshold level, a pull down switch is switched on at operation 308 which in turn pulls down a SS pin of the PWM IC below a SS threshold voltage (e.g., below 0.4 V) to stop the SS pin discharge circuit 310. At operation 312, the pulse circuit turns off and the SS pin voltage returns to a voltage level based on the remaining stored charge on the SS capacitance. This allows restoration of the normal PWM circuit function at operation 314.

Technical effects and benefits provided by a PWM system including the prompt dose mitigation circuit of the present disclosure include reducing the soft start upset duration by 2 orders of magnitude compared to conventional solutions. Output energy storage requirements are therefore reduced by 2 orders of magnitude resulting in much smaller energy storage banks. The prompt dose mitigation circuit also includes a leakage path that prevents low level persistent background radiation from inadvertently resetting the PWM IC. In this manner, the prompt dose mitigation circuit permits the output load to operate through prompt dose events without impacting downstream hardware while maintaining normal operation in a non-radiation environment.

The corresponding structures, materials, acts, and equivalents of all means or step-plus function elements in the claims below are intended to include any structure, material, or act for performing the function in combination with other claimed elements as specifically claimed. The description of the present disclosure has been presented for purposes of illustration and description but is not intended to be exhaustive or limited to the technical concepts in the form disclosed. Many modifications and variations will be apparent to those of ordinary skill in the art without departing from the scope and spirit of the disclosure. The embodiments were chosen and described to best explain the principles of the disclosure and the practical application, and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. A pulse width modulator (PWM) system comprising:
a pulse width modulator (PWM) integrated circuit (IC) configured to output power to a load, the PWM IC including a soft start (SS) circuit configured to perform a SS operation that sets a SS ramp time duration which controls a startup sequence operation of the PWM IC; and
a prompt dose mitigation circuit electrically connected to a SS input of the SS circuit, the prompt dose mitigation circuit configured to control the SS circuit to reduce the SS upset time duration of the startup sequence operation.

2. The PWM system of claim 1, wherein a reset of the startup sequence operation is initiated when a voltage level of voltage applied to the SS input is below a reset voltage threshold for a predetermined time duration.

3. The PWM system of claim 1, wherein the prompt dose mitigation circuit comprises:
an SS ramp tuning circuit configured to control a rate at which the voltage applied to the SS input ramps up and discharges; and
a reset circuit in signal communication with the SS ramp tuning circuit, the reset circuit configured to apply the voltage to the SS input having the voltage level that is below the reset voltage threshold for the predetermined time duration that initiates a reset of the startup sequence operation.

4. The PWM system of claim 3, wherein the SS ramp tuning circuit comprises:
a first SS capacitor including a first terminal connected to a ground reference and an opposing second terminal;
a second SS capacitor including a first terminal connected to the ground reference and an opposing second terminal connected to the second terminal of the first SS capacitor; and
a SS resistor including a first terminal connected to the SS input and an opposing second terminal connected to the second terminals of the first and second SS capacitors.

5. The PWM system of claim 4, wherein the reset circuit comprises:
a pull down switch including a switch input to receive a trigger current and a switch output connected to the SS input to apply the voltage in response to receiving the trigger current;
a timing resistor including a first resistor terminal connected to the switch input and an opposing second resistor terminal;
a trigger capacitor including a first capacitor terminal connected to the second resistor terminal of the timing resistor and an opposing second capacitor terminal connected to the ground reference;
a leakage resistor including a first resistor terminal connected to the first capacitor terminal of the trigger capacitor and an opposing second resistor terminal connected to the ground reference;
a p-type semiconductor- intrinsic semiconductor region-n-type semiconductor (PIN) diode including a cathode connected to the first resistor terminal of the leakage resistor, the first capacitor terminal of the trigger capacitor and the second resistor terminal of the timing resistor, and including an anode configured to establish electrical connection with a bias voltage source to receive a bias voltage; and
a bias capacitor including a first capacitor terminal connected to the ground reference and an opposing second capacitor terminal configured to establish electrical connection with the bias voltage source to receive the bias voltage.

6. The PWM system of claim 5, wherein the PIN diode generates the trigger current in response to detecting a prompt dose.

7. The PWM system of claim 6, wherein the PIN diode is a PIN photodiode.

8. The PWM system of claim 6, wherein the pull down switch is a transistor including:
an emitter connected to the ground reference;
a collector connected to the SS input to establish the switch output; and
a base connected to first resistor terminal of the timing resistor to establish the switch input and receive the trigger current that is output from the PIN diode.

9. A prompt dose mitigation circuit comprising:
a soft start (SS) ramp tuning circuit configured to control a rate at which voltage applied to a SS input of a SS circuit included in a pulse width modulator (PWM) integrated circuit (IC) ramps up and discharges; and
a reset circuit in signal communication with the SS ramp tuning circuit, the reset circuit configured to apply the voltage to the SS input having a voltage level that is below a reset voltage threshold for the predetermined time duration that initiates a reset of a startup sequence operation performed by the SS circuit.

10. The prompt dose mitigation circuit of claim 9, wherein the SS ramp tuning circuit comprises:
a first SS capacitor including a first terminal connected to a ground reference and an opposing second terminal;
a second SS capacitor including a first terminal connected to the ground reference and an opposing second terminal connected to the second terminal of the first SS capacitor; and
a SS resistor including a first terminal connected to the SS input and an opposing second terminal connected to the second terminals of the first and second SS capacitors.

11. The prompt dose mitigation circuit of claim 10, wherein the reset circuit comprises:
a pull down switch including a switch input to receive a trigger current and a switch output connected to the SS input to apply the voltage in response to receiving the trigger current;
a timing resistor including a first resistor terminal connected to the switch input and an opposing second resistor terminal;
a trigger capacitor including a first capacitor terminal connected to the second resistor terminal of the timing resistor and an opposing second capacitor terminal connected to the ground reference;
a leakage resistor including a first resistor terminal connected to the first capacitor terminal of the trigger capacitor and an opposing second resistor terminal connected to the ground reference;
a p-type semiconductor- intrinsic semiconductor region-n-type semiconductor (PIN) diode including a cathode connected to first resistor terminal of the leakage resistor, the first capacitor terminal of the trigger capacitor and the second resistor terminal of the timing resistor, and including an anode configured to establish electrical connection with a bias voltage source to receive a bias voltage; and
a bias capacitor including a first capacitor terminal connected to the ground reference and an opposing second capacitor terminal configured to establish electrical connection with the bias voltage source to receive the bias voltage.

12. The prompt dose mitigation circuit of claim 11, wherein the PIN diode generates the trigger current in response to detecting a prompt dose.

13. The prompt dose mitigation circuit of claim 12, wherein the PIN diode is a PIN photodiode.

14. The prompt dose mitigation circuit of claim 12, wherein the pull down switch is a transistor including:
an emitter connected to the ground reference;
a collector connected to the SS input to establish the switch output; and
a base connected to first resistor terminal of the timing resistor to establish the switch input and receive the trigger current that is output from the PIN diode.

15. A method of controlling a soft start (SS) circuit to control a startup sequence operation performed by a SS circuit included in a pulse width modulator (PWM) integrated circuit (IC), the method comprising:
electrically connecting a prompt dose mitigation circuit to a SS input of the SS circuit;
detecting a prompt does event via the prompt does mitigation circuit; and
initiating a reset of the startup sequence operation in response to detecting the prompt dose event; and
outputting a voltage from the prompt dose mitigation circuit to the SS input to reduce the SS upset time duration of the startup sequence operation.

16. The method of claim 15, wherein the reset of the startup sequence operation is initiated when a voltage level of the voltage applied to the SS input is below a reset voltage threshold for a predetermined time duration.

17. The method of claim 16, further comprising:
applying the voltage to the SS input using a reset circuit included in the prompt dose mitigation circuit, the voltage having the voltage level that is below the reset voltage threshold for the predetermined time duration that initiates a reset of the startup sequence operation; and
connecting a SS ramp tuning circuit included in the prompt dose mitigation circuit to the SS input to control a rate at which the voltage applied to the SS input ramps up and discharges.

18. The method of claim 17, further comprising:
delivering a trigger current to a pull down switch included in the reset circuit; and
applying the voltage to the SS input via the pull down switch receiving the trigger current.

19. The method of claim 18, further comprising detecting the prompt dose event via a p-type semiconductor- intrinsic semiconductor region-n-type semiconductor (PIN) diode included in the reset circuit; and
outputting the trigger current from the PIN diode in response to detecting the prompt dose event.

20. The method of claim 19, further comprising detecting radiation energy produced in response to the prompt dose event via the PIN diode, and outputting the trigger current from the PIN diode in response to detecting the radiation energy.
